(19) United States
(12) Patent Application Publication
(10) Pub. No.: US 2004/0096800 A1
(43) Pub. Date: May 20, 2004

(54) Removable reinforcement impression tray

(76) Inventors: Jack Tucker, San Antonio, TX (US); David Tucker, Houston, TX (US)

Correspondence Address: David A. Tucker, 10306 Kings Grant Dr., San Antonio, TX, 78230, US

(21) Appl. No.: 10/705,556

(22) Filed: Nov. 10, 2003

Related U.S. Application Data
(62) Division of application No. 10/288,740, filed on Nov. 6, 2002.

(51) Int. Cl. A61C 9/00

(52) U.S. Cl. 433/38; 433/37

(57) ABSTRACT

A dental impression tray which can be made flexible after insertion in the patient's mouth. A joint or area of flexibility in the tray's posterior is reinforced prior to intraoral placement by a removable wire running through hooks in the tray's rim. Removing the wire after the patient bites imparts flexibility to the joint, and then the tray's frame becomes less flexible once the impression material cures. The tray's initial rigidity facilitates handling, and its subsequent flexibility reduces the frame's plastic memory, thereby reducing springback distortions.

### CROSS-REFERENCE TO RELATED APPLICATIONS

This application is a divisional and continuation-in-part of application Ser. No. 10/288,740, titled, “Variable Rigidity Impression Tray” filed Aug. 27, 2002 and claims priority from provisional application No. 60/315,640 filed on Aug. 29,2001 titled, “Impression Tray with Removable or Temporary Reinforcement.”

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF INVENTION

1. Field of the Invention

This invention relates to methods of taking dental impressions using dual arch trays.

2. Description of the Related Art

Many dental and orthodontic procedures require the dentist to form an impression of the patient's teeth, either alone or in conjunction with the gums and vestibular anatomy. This impression typically is either used directly by the dentist or orthodontist to analyze the patient's mouth structure or is used to form a plaster replica of the patient's teeth, gums, and vestibule. Such impressions are typically used to produce dental replacement components and dental assemblies such as crowns, teeth, bridgework, dentures and other oral prostheses.

Dentists use trays to carry impression material to the mouth and to support the moldable material intraorally until it cures. The design of the tray depends on the size and shape of the area to be recorded. One type of dental impression tray—often referred to as a multiple impression tray, a dual arch tray, or a triple tray—is used to take impressions of both upper and lower portions of a patient's teeth and mouth and to provide concurrently an impression of the relative positions of the upper and lower teeth during a bite. It typically includes an upper trough and a bottom trough, each filled with impression material such as a setable material. The upper impression corresponds to an impression section of maxilla, the lower impression corresponds to a complimentary section of mandible, and the two complimentary impressions jointly provide an impression of the bite relationship of mandible to maxilla. In comparison to other impression-taking methods, using a dual arch tray is cheaper and faster.

Two kinds of dual arch trays are generally being marketed. One is metal with a disposable cloth or paper insert. These metal trays are expensive. They require cleaning and sterilization before reuse, which is inconvenient.

The other kind of dual arch tray is usually made of totally disposable materials such as plastic, paper, cloth, mesh, or a combination of these. The trays are inexpensive, which gives them the convenience of disposability. However, their flexibility and plastic memory can cause intraoral distortions in the impression.

In other words, the lack of complete rigidity in a tray can create a “springback” distortion transfer from the tray to the impression material on release of pressure to the tray sides, which is inadvertently applied by hard- and soft-tissue interferences at some point during the impression-making process. For example, pressure can be generated by the tongue, by occlusal forces pushing material against the tray wall, by the cheeks, or by tray impingement of gingival tissues and teeth. This pressure flexes the tray while the impression material sets, causing inaccuracies in the impression when the distorted tray attempts to return to its original shape upon removal from the mouth. These inaccuracies are then transferred to the master cast when it is made in the dental laboratory. See U.S. Pat. No. 5,636,985 by Simmen, et al., dated Jun. 10, 1997; U.S. Pat. No. 5,513,985 by Robertson dated May 7, 1996.

The pressure of the tray against the gingiva or other soft tissues can also be uncomfortable to the patient. This discomfort can cause the patient to open or shift his bite while the impression material is setting, which can ruin the impression.

A tray for reducing springback distortion is described in U.S. Pat. No. 5,513,985 by Robertson dated May 7, 1996. The walls of this impression tray are joined by wires which allow movement of the walls during the taking of the impression and afterwards as the impression material is being cured or set. The impression material, once set, is said to maintain the shape of the wire due to the stronger memory of the impression material over the wire, which is weaker in memory. Likewise, Jones, R H, Jones N L and Hammond T W in the January 2001 issue of The Journal of the American Dental Association (Vol 132, p. 73) describe a method of weakening the tray's posterior bar prior to use by removing some plastic from a small section of it.

This alleged solution is merely a different kind of flexible tray—it strikes a different balance between rigidity and flexibility in the tray than that which is inherent to competing trays, and except for the reinforcement provided by the impression material, the tray's rigidity characteristics do not change. Further, this tray design relieves intraoral pressures in only the buccal-lingual direction.

Another technique for minimizing springback distortion is to fabricate a custom tray. See, e.g., U.S. Pat. No. 5,011,407 by Pelerin dated Apr. 30, 1991. Custom trays are well known in the art. They are time consuming, can be technique-sensitive, and use a significant quantity of expensive materials.

There is a need for a dual arch tray which is supportive during placement and which is subject to minimal springback distortion.

### BRIEF SUMMARY OF THE INVENTION

The invention provides a dental impression tray that is supportive during placement and which is subject to minimal springback distortion. The preferred embodiment is a dual arch impression tray having a bent support wire under tension that runs through several hooks arranged along the outside of the tray's frame. It has a joint in its frame, preferably in the posterior area, which permits the tray to adapt its shape in response to intraoral forces. Preferably, an immobilizing agent such as an uncured composite or adhesive has been applied to the joint so it can lock into a stress-relieved position as the impression material is curing. The support wire is pulled free immediately after the patient bites into the impression material, which allows the two parts of the frame separated by the joint to shift in response to biting forces, tissue impingement, and other intraoral forces—thereby relieving distortion-inducing stresses in the tray. The uncured material at the joint self-cures, or is light-cured, or is cured by the application of a chemical accelerant, shortly after the patient has bitten, which permits the impression to withstand removal stresses and routine laboratory handling with minimal distortion.

It is therefore an object of the present invention to provide an improved dental impression tray.

Another object of the invention is the provision of a dental impression tray having a means of frame reinforcement that can be partially defeated during impression-taking while the impression material is still somewhat viscous.

Another object of the invention is the provision of a dental impression tray having a frame design that relieves certain forces applied to it during impression-taking.

Another object of the invention is the provision of a dental impression tray which will minimize the springback distortions created by the memory found in plastics or metals traditionally used in impression trays that have one-piece frames.

Another object of the invention is the provision of a dental impression tray which is comfortable to the patient during impression-taking.

Another object of the invention is the provision of a dental impression tray which can become flexible enough to yield to intraoral pressures.

Another object of the invention is the provision of a preformed dual arch dental impression tray whose frame partially adapts itself to the patient's anatomy with no appreciable memory in the frame.

Another object of the invention is the provision of a tray that will be stiffer when you are working with it outside the mouth than it will be in the mouth while the impression material is setting.

Another object of the invention is the provision of a tray that has great tasting components that will appeal to patients

Further objects and advantages of the invention will become apparent from a consideration of the drawings and ensuing description.

### BRIEF DESCRIPTION OF THE SEVERAL VIEWS OF THE DRAWING

Some of the features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a perspective view of a preferred embodiment of the tray.

FIG. 2 is a detail view of the tray's joint.

FIG. 3 is a detail view of one of the hooks on the tray's outside rim.

### DETAILED DESCRIPTION OF THE INVENTION

1. Design of Preferred Embodiment.

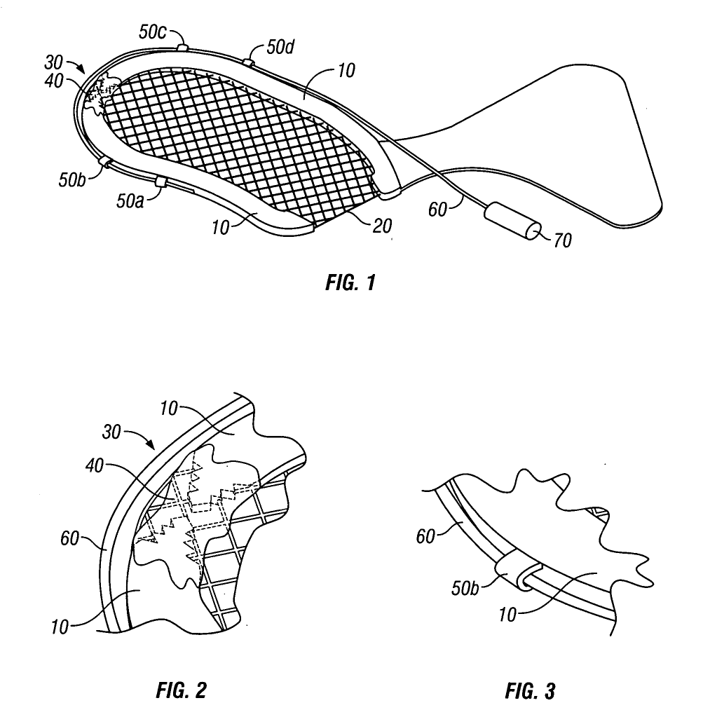

FIG. 1 shows a perspective view of the tray. In accordance with FIG. 1, the tray consists of: (a) a frame 10, preferably made of a rigid material such as plastic or metal, (b) a membrane 20 attached to or integral with the frame, which is preferably made of a close, thin, hydrophobic mesh netting (but which may also take the form of a paper, a sheet of plastic, filaments, gauze or other plastic or paper-like material), (c) a joint 30, which separates the frame into two sections that can move fairly independently, (d) an immobilizing agent 40, which is somewhat viscous and is packed through the membrane and encases the ends of the frame near the joint, (e) substantially identical hooks 50a, 50b, 50c, and 50d, which are curved projections that are integral with or attached to the frame, (e) a wire 60, which is preferably made of straight stainless steel rod which was recently bent into a curved shape, so as to pull the membrane taut and yet still retain the memory of the rod's previous shape, and which is sized to pass easily through the hooks, and (e) a grip 70, which is optional and is preferably a plastic-covered butt connector crimped onto the wire. For clarity, we show a low-walled tray, but the invention can also be embodied as a higher-walled tray.

2. Manner of Operation.

The tray is operated in the following manner. The user manually bends wire 60 from an initially straight shape in order to snap or thread it through hooks 50a, 50b, 50c, and 50d. An ordinary small-gauge stainless steel orthodontic wire has an acceptable combination of strength, smoothness, and ease of removal. The force provided by the memory in wire 60 reinforces the two sections of frame 10 so as to restrict their movement at joint 30 and so as to hold the membrane in a slightly tensioned state. This tension will later cause the membrane to provide support for the impression material as it is delivered to the mouth.

Then, the user applies an immobilizing agent 40 to joint 30 so that it encases the ends of the frame near joint 30 as well as the contiguous parts of mesh 20. Although a variety of materials will service, the immobilizing agent is preferably an uncured, mixed-two-part, self-curing dental composite.

The user then applies his preferred impression material to both sides of membrane 20 and delivers the impression-material-filled tray to the mouth. The patient bites, and the user visually verifies that the bite is satisfactory. The user then uses grip 70 to remove wire 60 from the tray and mouth with a smooth pull. The removal of wire 60 permits the two sections of frame 10 to shift at joint 30 in response to intraoral pressures applied to the frame, and immobilizing agent 40 should still be sufficiently viscous at this point to permit easy movement. Ideally, as soon as practicable after the intraoral pressure is relieved, immobilizing agent 40 should self-cure or be light-cured by the user to a rigidity sufficient to immobilize the two sections of frame 10. The user removes the impression and tray from the mouth once the impression material and immobilizing agent 40 have cured sufficiently.

3. Alternative Embodiments

The preferred embodiment of the invention described above is one of many possible ones. The tray need not have all the features described in the preferred embodiment. For example, it could be designed simply to have temporary or removable reinforcement in its frame without using immobilizing material. Alternatively, the tray's frame could be traditional in design and simply have a more flexible posterior bar.

a. Imparting Temporary or Removable Rigidity.

There are many ways to impart temporary or removable rigidity to the tray prior to inserting it in the patient's mouth. If the tray design uses a wire for reinforcement, the position, shape, and number of the hooks can be changed. Alternatively, the wire could be passed through one or more channels, staples, tunnels, loops or tubes that are attached to or integral with the frame. For example, the membrane could be made to extend beyond the rim of the tray, and the wire could be “sewed” through it or passed through a tunnel-like looped section of membrane. Likewise, several small, flexible, plastic flaps that contains a hole could extend from the tray's frame in the plane of the membrane; the user would simply bend the flap up to orient the hole to receive the wire. Multiple support wires could also be used to impart additional reinforcement to the tray without sacrificing ease of removal. The wire itself could be made of metal or plastic. The non-grip end of the wire could also have a plastic-encased tip so as to reduce the perceived risk that pulling the wire will scratch tissues. Of course, the grip for the wire, such as a looped section of wire or an attached piece of plastic, is optional. Further, the means for removing the wire support could vary—rather than pulling the wire free, the user could manipulate the wire to unhook it from the frame and then leave it in place while the impression material cures. Alternatively, rather than use the memory in the wire to provide structural support, the wire's tensile strength could be used. In this embodiment, a wire under tension could affix two sections of the frame to each other and be severed when appropriate.

Instead of using wire, reinforcement could also be applied directly at the joint. One method would use a temporary or removable immobilizing agent. For example, the user could encase the joint in ice, chocolate, thermoplastic, or another substance which would become flexible or viscous when heated. Heat provided by oral tissues could be used to melt the material, or additional heat could be delivered by the user through a heat-transmissive structure in the tray (e.g., a resistor imbedded in the tray attached to a wire projecting from the tray's handle). If a resistor is to be used, then the meltable material could be encased in a flexible, heat-insulating structure so as to protect oral tissues. The joint could also be immobilized by providing a gas- or fluid-filled tube under pressure, engaged with the tray's frame or only its joint, that can become disengaged when popped with an instrument so as to release the enclosed pressurized air or liquid. Alternatively, the tray's frame could be reinforced by a layer or bridge of wax, orthodontic wax, chocolate, cookie, or other material having a similar consistency which spans the lingual and buccal sides of the tray, preferably in its anterior region. The material would brace the engaged walls of the tray—perhaps by partially encasing them, and the support it gives would be abated once the patient bites through the material.

Another means of immobilizing the joint could be to span a pin across the joint which inserts into mating holes in both frame sections, operating in much the same way that a door latch secures a door. The pin could be metal or plastic, and to inhibit rotation around the pin it should preferably be curved along its length or have a cross section that keys into a non-round mating hole. Alternatively, the latch structure could be as simple as a thick removable pin or wire threaded or inserted through a section of the membrane that loosely loops around the posterior part of the tray's frame. Like pulling a large stick from a bundle of several small sticks, the void created by the missing pin would permit the relative movement of the two sections of frame that are within the joint. In the latch embodiment, the pin could be removed after the tray is intraorally placed by pulling it free with an instrument or by pulling an attached wire, dental floss, or long handle.

Yet another method of imparting reinforcement directly to the joint would be to mechanically hold the two sections of the frame together in a fixed relationship. This could be done by means of a clamp—such as a hemostat whose rubber-encased tip spans both sides of the joint. The clamp could even serve the function traditionally served by the handle used in traditional dual arch impression trays. A similar design would let the hand itself act as a clamp. This design would have a long, rigid, curved, metal bar that is removably attached to the lingual section of the frame. This bar would act as a second handle, and the user would manually press it into or hold it against the main handle. Also, as alluded to earlier, separated sections of the frame could be mechanically held or “clamped” together by means of a wire. This wire would attach to the far section of the frame near its end, run through or along the other frame section (which might have a guide for the wire), and either (i) be attached under tension or not to the tray's handle or (ii) be held by the user. The wire could be cut or unattached after delivery of the impression material to the mouth, which would cause the separate frame sections to disengage from each other at the joint, permitting their movement relative to each other.

Alternatively, reinforcement could be removed from the tray by creating the joint after delivering the impression material to the mouth. The user would sever the frame in its posterior section with a cutting instrument, after the patient has bitten into the impression material. The disadvantages to this method are: (i) cutting the frame would tend to disturb any immobilizing agent applied at or near the break; (ii) providing for a separate joint at or near the break to which immobilizing agent has been applied would provide undesirable bulk in the retromolar area that could interfere with the patient's bite, and (iii) the insertion or removal of the cutting instrument is likely to induce the patient to adjust his bite, thereby ruining the impression.

A variation of the cutting embodiment is to change the rigidity of the frame by applying electric current, through a wire running along or through the tray, to one or more resistors that are encased in the frame. To avoid tissue damage, the plastic around the resistor should be selected from among one of the many materials used in custom trays that become malleable at relatively low temperatures. Alternatively, if the resistor were comprised of a brittle material having a low melting point, the resistor could sever like a fuse, thereby removing support from the tray.

Yet another way of providing temporary reinforcement similar to the clamping method could be to provide U-shaped support tray on which the main tray rests which is removably engaged with the main tray. After the patient bites, the support tray could be disengaged from the main tray by a variety of methods (e.g., severing the means of connection, pulling a pin or key that latches the two structures together, removing the part of the support tray's handle that projects from the U-shaped section so that it disengages under the force of gravity). The structure can remain in the mouth until the impression material cures, if desired.

b. Imparting Rigidity to a Tray After the Bite.

There are also various ways to design a joint and immobilizing agent that will impart rigidity to a tray after the patient bites. The design and composition of the joint, of course, depends upon the means by which it is to be immobilized. The preferred embodiment describes the joint as an open, mesh-filled gap between the frame's two sections, but it could also be one or more traditional joints having a more limited range of motion—such as a prismatic joint (e.g., a key-and-keyhole joint), rotational joint (e.g., a hinge, a ball-and-socket joint, looped rings, thread-and-nut joint), or elastic joint (e.g., the two sections of frame bridged by a flexible material, or a sponge-like material soaked in immobilizing agent, or an immobilizing-agent-filled tube, or a void). As used in this application, the term “joint” is defined to also include a gap or separation in the frame. Such a gap could be created by cutting the posterior bar, but preferably the gap should be arranged to cause the two sections of posterior bar to overlap each other. After the impression material cures around this “overlapping arcs” joint design, the impression material would inhibit flexure of the joint by inhibiting movement of the tip of each arc. The joint could be varied in number, position and orientation so as to relieve stress from various locations and directions.

Alternatively, the reinforcement could be removed by imbedding a resistor in the tray's posterior which is attached to a wire which can be used as a transmitter of electrical current.

The joint or the posterior section would be made from a thermoplastic material which, after being heated and cooled by the application and removal of current to the resistor, would lock the tray into its stress-relieved position.

Thus, the reader will see that the devices and methods described above provide a means for imparting flexibility when needed in a dual arch impression tray. Its pre-impression rigidity facilitates handling, while its flexibility during impression-taking minimizes springback distortion.

While various embodiments of the present invention have been shown and described above, it should be understood that they have been presented by way of example only, and not limitation. Many other variations are possible. It will be obvious to those skilled in the art that changes and modifications may be made without departing from the spirit of this invention in its broader aspects. Thus, the breadth and scope of the present invention should not be limited by any of the above described exemplary embodiments. The aim in the appended claims is to cover all such changes and modifications as fall within the true spirit and scope of this invention.

What is claimed is:

1. A method for taking a dental impression comprising the steps of:
selecting a dual arch dental impression tray suitable for taking an impression of the oral structure of interest;
placing a quantity of impression material in the tray;
placing the impression-material-loaded tray in the patient's oral cavity;
causing the patient to bite into the impression material;
utilizing a means for reducing the rigidity in the tray's frame. allowing the impression material to cure; and
removing the impression and tray from the patient's oral cavity.

2. The method of claim 1 wherein the means is utilized by severing a connection member within the tray's frame that affixes two sections of the frame together.

3. The method of claim 1 wherein the means is utilized by manipulating a component of the tray.

4. The method of claim 3 wherein the component manipulated is selected from the group consisting of wires, strings, rods, levers, handles and pins.

5. The method of claim 1 wherein the means is a wire removably attached to the tray's frame and which is utilized by pulling it.

6. The method of claim 1 wherein the means is a pin engaged with the tray's frame and which is utilized by pulling or pushing on it directly or indirectly.

7. The method of claim 1 wherein the means is a handle attached to the tray and which is utilized by either disengaging it from the tray or releasing the user's grip.

8. The method of claim 1 wherein the means is a clamp securing two parts of the tray to each other and which is utilized by releasing or removing the clamp.

9. The method of claim 1 wherein the means is low temperature thermoplastic material within the tray engaged with a heat-generating or heat-conducting component and which is utilized by applying electricity or heat.

10. A method for taking a dental impression comprising the steps of:
selecting a dual arch dental impression tray suitable for taking an impression of the oral structure of interest;
procuring a support material which either loses rigidity as its temperature changes from room temperature to intraoral temperatures or can be bitten through;
applying the support material to the tray;
placing a quantity of impression material in the tray;
placing the impression-material-loaded tray in the patient's oral cavity;
causing the patient to bite into the impression material;
allowing the impression material to cure; and
removing the impression and tray from the patient's oral cavity.

11. The method of claim 10 wherein the support material contains a food.

12. The method of claim 11 wherein the food contains a sugar.

13. The method of claim 11 wherein the food is selected from the group consisting of chocolate, vanilla, cookies, and bread.

14. The method of claim 10 wherein the support material contains a wax.

15. The method of claim 10 wherein the support material contains a plastic.

16. A method for taking a dental impression comprising the steps of:
selecting a dual arch dental impression tray suitable for taking an impression of the oral structure of interest;
adding a component to the tray which can help support the tray before it is delivered to the mouth and which can be removed, adjusted or altered to reduce such support once the patient has bitten into the tray;
placing a quantity of impression material in the tray;
placing the impression-material-loaded tray in the patient's oral cavity;
causing the patient to bite into the impression material;
removing, adjusting or altering the component so as to effect a reduction in the amount of support it was giving to the tray;
allowing the impression material to cure; and
removing the impression and tray from the patient's oral cavity.

17. The method of claim 16 wherein the component added is a removable wire.

18. The method of claim 16 wherein the component added is a movable pin attached to the tray.

19. The method of claim 16 wherein the component added is a clamping instrument.

20. The method of claim 16 wherein the component added is the user's hand removably affixing two parts of the tray to each other.
